(19) United States
(12) Patent Application Publication
(10) Pub. No.: US 2011/0041775 A1
(43) Pub. Date: Feb. 24, 2011

(54) Rolling device for pet exercising and floor cleaning

(76) Inventors: Bakhytbek Z. Ussen, New York, NY (US); Zhaniya B. Ussen, New York, NY (US); Timur B. Ussen, New York, NY (US)

Correspondence Address: Zhaniya B. Ussen;#401, B-513, 545 8th Avenue, New York, NY, 10018, US

(21) Appl. No.: 12/461,744

(22) Filed: Aug. 24, 2009

(51) Int. Cl. A01K 15/02

(52) U.S. Cl. 119/702

(57) ABSTRACT

A rolling device for pet exercising and floor cleaning is generally disclosed comprising a hollow body (1), of spherical or cylindrical shape, to securely enclose a small pet, and ventilation holes (2) to allow supply of fresh air into the hollow body for the pet breathing, and a litter collector (6) with sticky, bristly and/or magnetic surface on an exterior surface of the hollow body capable of collecting small-sized litter. The hollow body and the litter collector are provided with transparent windows for the small pet to be able to view outside objects. The device can be supplemented with area guarding to prevent the device to roll outside the designated perimeter and get stuck under furniture, as well as by a stand for placement of the device inside a small pet cage or on top of a desk, so the pet can exercise occupying relatively small area of surface.

### CROSS-REFERENCE TO RELATED APPLICATIONS

Not applicable.

### BACKGROUND—STATEMENT REGARDING FEDERALLY SPONSORED RESEARCH OR DEVELOPMENT

Not applicable.

### REFERENCE TO MICROFICHE APPENDIX

Not applicable.

### BACKGROUND

1. Field of Invention

The present invention related to a combination of a toy, small pet exercising, and floor cleaning devices designed primarily to be employed in conjunction with small pets, such as domesticated hamsters, rats, mice, Guinea pigs, and the like, that allows a small pet to walk inside the roll to move it around the floor of a room while cleaning the surface of the floor from animal and human hair and other small-sized litter.

2. Description of Prior Art

Pet owners—especially those who are getting tired at work and elderly—are often facing two problems, one of which is the need for regular exercising of a pet in order to maintain its good physical condition, health, and mental alertness. However, a period of activity of a pet may not be fully consistent with one of the pet owner. Moreover, while a pet may run and play effortlessly for a long time, this may be difficult to a pet owner especially if the latter is tired, aged or sick.

Small pets are typically restricted in the areas in which they can roam. For example, it is not uncommon for hamsters to be confined to a cage. Due to the limited space available within these environments, pets normally do not get an adequate amount of exercise. Therefore, it is desirable to allow them to leave their normal surroundings for purposes of exercise and for a change in scenery. However, this may not be always safe for both small pets and the surroundings, as the small pets can easily get lost, dirty, injured, or otherwise, they can scratch the floor and other surfaces making them unattractive. Thus it is an issue how to make the small pet safely walking around and entertain itself while avoiding such unpleasant consequences for the small pet and the surroundings.

Another problem may be caused by small-sized litter, like tiny pieces of paper, thread, oddments of an assembly material, small-sized parts of toys, and the like, generally resulting from children's activity, which is often present on floor surface in children's rooms. Small-sized litter, like fallen down animal and human hair, can also be found in other parts of a house, e.g., living rooms, bedrooms, bathrooms and toilet rooms. Cleaning of floors from such small-sized litter is always a time consuming and often not a very pleasant activity.

Therefore, there has been a need for a small pet toy which moves in response to action of the pet, thereby freeing the owner from the sometimes onerous and time-consuming duties of entertaining a bored, unhappy pet, ensures safety for the pet and surrounding objects during the pet exercising activity, and cleans floors from animal and human hair and other small-sized litter, and at the same time providing the pet owner with the pleasurable entertainment of watching her small pet active.

A search of the prior art did not disclose any patents that read directly on the claims of the instant invention; however, the following references were considered related:

| U.S. Pat. No. | Inventor | Issue Date |
|---|---|---|
| 7,104,222 | Tsengas | Sep. 12, 2006 |
| 7,367,283 | Aboujaoude, et al. | May 6, 2008 |
| 7,320,296 | Morrison | Jan. 22, 2008 |
| 6,945,195 | Morrison | Sep. 20, 2005 |
| 7,066,780 | Jamison | Jun. 27, 2006 |
| 6,550,089 | Ussen | Apr. 22, 2003 |
| 6,327,741 | Reed | December 2001 |
| 6,209,491 | Olson | Apr. 3, 2001 |
| 5,865,509 | Monahan | February 1999 |
| 5,839,156 | Park et al. | November 1998 |
| 5,776,215 | Amoretti | July 1998 |
| 5,709,007 | Chiang | January 1998 |
| 5,560,077 | Crotchett | October 1996 |
| 5,542,376 | Udelle, et al. | Aug. 6, 1996 |
| 5,507,058 | Minami et al. | April 1996 |
| 5,443,036 | Amiss et al. | Aug. 22, 1995 |
| 5,363,534 | Dekker | November 1994 |
| 5,334,076 | Shinozuka | August 1994 |
| 5,125,361 | Rowlands | Jun. 30, 1992 |
| 4,927,401 | Sonesson | May 1990 |
| 4,85,4000 | Takimoto | August 1989 |
| 4,750,234 | Quearry | June 1988 |
| 4,726,800 | Kobayashi | February 1988 |
| 4,541,814 | Martin | September 1985 |
| 4,480,401 | Matsushiro | November 1984 |
| 4,471,567 | Martin | September 1984 |
| 4,438,588 | Martin | March 1984 |
| 4,209,942 | Lohr | July 1980 |
| 3,742,547 | Sohmer | July 1973 |

Consequently, a need has therefore been felt for an improved mechanism that creates an exercising toy for a small pet that also frees its owner from floor cleaning job.

### SUMMARY OF INVENTION

In one aspect, the invention features an entertainment and exercising device for use by small pets. In another aspect, the invention features a rolling device for cleaning floors. The device has a hollow body, of spherical or cylindrical shape, to securely enclose a small pet, and ventilation holes to allow supply of fresh air into the hollow body for the pet breathing, and a litter collector on an exterior surface of the hollow body that is capable of collecting small-sized litter.

The device can be supplemented with area guarding to prevent the device to roll outside the designated perimeter and get stuck under furniture, as well as by a stand for placement of the device inside a small pet cage or on a desk.

### Objects and Advantages

Accordingly, several objects and advantages of the present invention are:
(a) to provide a small pet toy which moves in response to action of the pet, thereby freeing the pet owner from the sometimes onerous and time-consuming duties of entertaining a bored, unhappy pet, ensures safety for the pet and surrounding objects during the pet exercising activity, and cleans floors from human and animal hair and other small-sized litter, and at the same time providing the pet owner with the pleasurable entertainment of watching her active pet;
(b) to provide an exercising device to have a small pet expend its surplus energy at the periods of its activity, thereby developing improved muscle tone, alertness, coordination, and better sleeping habits;
(c) to provide a small pet entertainment and exercise stimulator that would safely relieve the pet from boredom by providing amusement, and saving areas of household furniture from damage;
(d) to provide a small pet exercising device which can be used inside pet cage and outside of it;
(e) to provide a device allowing a small pet to walk safely inside the device without a risk of being eaten or harmed by a dog or other larger animal or an object outside the device;
(f) to provide a device allowing a small pet to walk outside its cage without leaving its excrements on floor and carpets;
(g) to provide a device which is easily assembled and disassembled;
(h) to provide a pet rolling device which is leak-proof and lightweight;
(i) to provide a pet rolling device which is easy to operate and clean;
(j) to provide a rolling cleaning device for various floor and other horizontal surfaces which does not require its user to manually move the device in the process of cleaning;
(k) to provide a rolling cleaning device for various floor and other horizontal surfaces which does not require its user to bend in the process of cleaning;
(l) to provide a rolling cleaning device for various floor and other horizontal surfaces which is convenient in use and simple in operation;
(m) to provide a rolling cleaning device which will allow its user to combine the process of cleaning with other activities, like playing a game, watching a television program, reading, cooking, talking, etc.;
(n) to provide a rolling cleaning device which will allow aged, sick and handicapped people to clean various floor and other surfaces from small-sized litter without a side help.

Further objects and advantages are to provide a pet rolling cleaning device having the ready availability of various attachments allowing the single device to be suitable for different surfaces and types of litter, which is simple to use, easy to replace attachments and inexpensive to manufacture. Still further objects and advantages of our invention will become apparent from a consideration of the drawings and ensuing description. It is intended that all such additional attachments, as well systems, methods, features, and advantages be included within this description, be within the scope of the present invention, and be protected by the accompanying claims.

### DRAWING FIGURES

The accompanying drawings further describe the invention.

FIGS. 1, 2, 3, and 5 show various aspects of the device constructed in accordance with the invention.

FIG. 4 shows the same device with a hollow body as a cylinder and a litter collector made as a roller.

FIG. 6 shows the area guarding to prevent the device to roll outside the designated perimeter.

### REFERENCE NUMERALS IN DRAWINGS

| | | | |
|---|---|---|---|
| 1 | hollow body | 2 | ventilation holes |
| 3 | opening in the hollow body | 4 | lid |
| 5 | fastener | 6 | litter collector |
| 7 | window | 8 | closable split |
| 9 | hemisphere | 10 | stand |
| 11 | pin | 12 | pinhole |
| 13 | area guarding | 14 | strip |
| 15 | connector | 16 | magnet or Velcro |

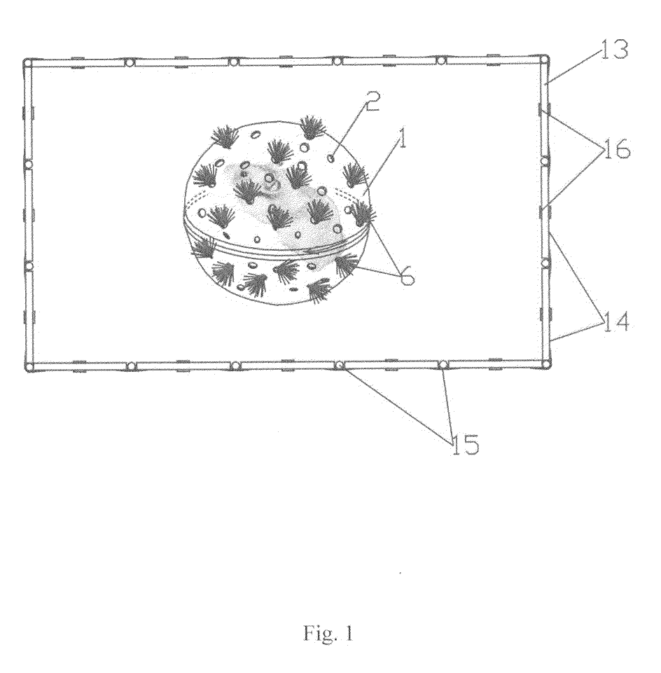

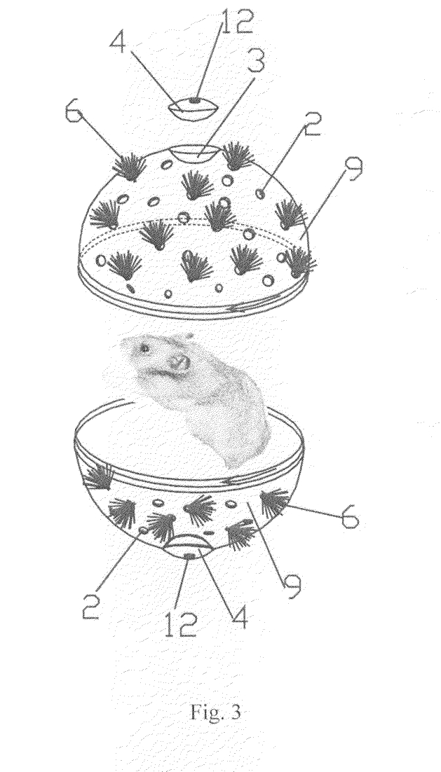

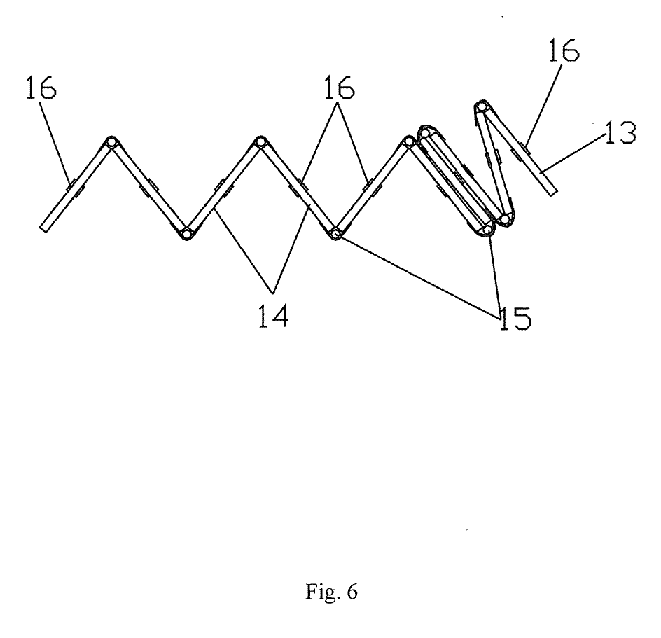

### Description of Invention—FIGS. 1-3 and 6—Preferred Embodiment

A preferred embodiment of the device of the present invention is illustrated in FIGS. 1-3, and 6. The device has a hollow spherical body 1 comprising of two hemispheres 9, and a litter collector 6. In the preferred embodiment, the hollow spherical body is made of two hemispheres 16 capable of unlocking and revealing room to accommodate a small pet, and securely closing to form the sphere. The litter collector 6 is a removable cover made of an elastic material with sticky, bristly and/or magnetic surface having a closeable split 8 with zip-fastener 5 to provide access to the hollow spherical body 1 and to replace the cover. The litter collector 7 is placed over the hollow spherical body 1. Both the hollow body 1 and the litter collector are provided with a plurality of ventilation holes 2 to allow the small pet within the hollow body 1 to breathe. In the preferred embodiment the hollow body 1 is made of transparent plastic, and the litter collector 6 is having transparent windows 7 so the small pet within the hollow body can easily view outside objects. An area guarding 13 is used to prevent the device containing the small pet to roll outside the designated perimeter. The area guarding is consisting of a number of strips 14, which are connected by means of connectors 15 to form a desirable configuration of the perimeter and to collapse into stockpile. The strips 14 are provided with magnets or Velcro 16 to hold the strips collapsed into the stockpile together.

A device is operating as follows: When a small pet is placed inside the hollow body 1, the latter is securely closed, and the litter collector 6 is placed over the hollow body and zip-fastened, the small pet is looking into a window 7 pressing it with its front legs, the device starts its movement, and—while it is rolling—the litter collector 6 picks-up human and animal hair, threads and the like small-sized litter from a floor on its way.

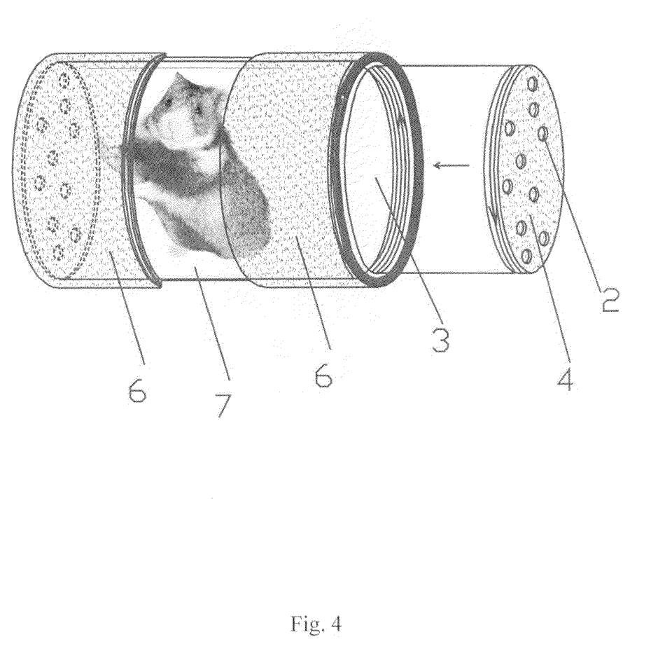

### Description of Invention—FIG. 4—Alternative Embodiment

FIG. 4 shows the device as a hollow transparent cylinder with the litter collector 6 made as two multi-layer rolls of removable sheets with sticky surface placed over the hollow cylinder at its margins providing a window 7 for the small pet viewing in the middle. Ventilation holes 2 are made throughout two lids 4 covering the corresponding openings 3 made at the opposite sides of the hollow cylinder.

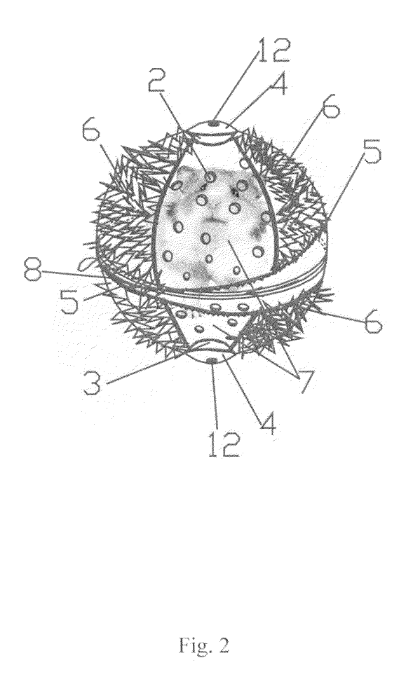

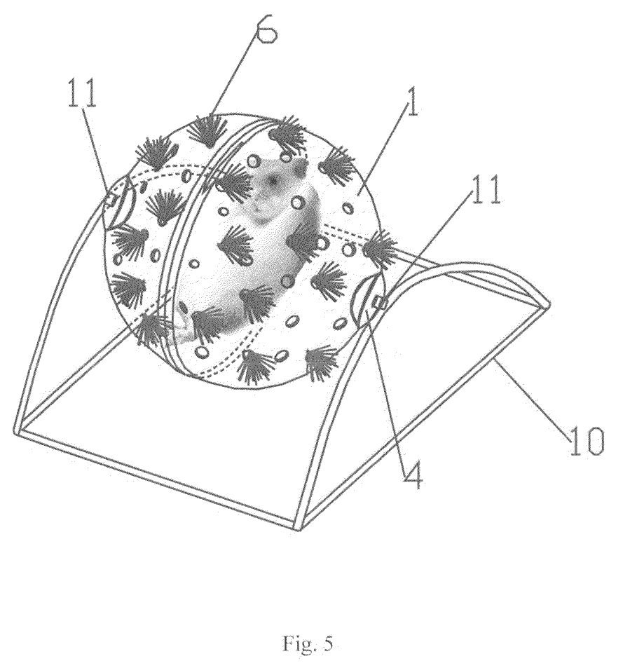

### Description of Invention—FIGS. 2, 3, and 5—Additional Embodiment

An additional embodiment is shown in FIGS. 2, 3, and 5, where each of hemispheres 9 is having a lid 4 containing a pinhole 12. The device is supplemented with a stand having two pins 11 corresponding to the pinholes 12. When the pins 11 are placed inside pinholes 12 the device hangs on the stand and is capable of rotating top-down. The stand with device can be placed inside the small pet cage or on top of the desk, so the small pet can exercise occupying relatively small area of surface.

### Conclusion, Ramifications, and Scope

Accordingly, the reader will see that the rolling device of this invention can be used to provide a combination of a toy, small animal exercising, and floor cleaning devices designed primarily to be employed in conjunction with small animals, such as domesticated hamsters, rats, mice, Guinea pigs, and the like, that allows a small animal to walk inside the roll to move it around the floor of a room while cleaning the surface of the floor from animal and human hair and other small-sized litter. Furthermore, the device has additional advantages in that:
it provides a device which moves in response to action of the pet, thereby freeing the owner from the sometimes onerous and time-consuming duties of entertaining a bored, unhappy pet, ensures safety for the pet and surrounding objects during the pet exercising activity, and cleans floors from pet hair and other small-sized litter, and at the same time providing the pet owner with the pleasurable entertainment of watching her active pet;
it provides a device to have a pet exercise and expend its surplus energy at the periods of its activity, thereby developing improved muscle tone, alertness, coordination, and better sleeping habits;
it provides a pet entertainment and exercise stimulator that would safely relieve the pet from boredom by providing amusement and saving areas of household furniture from damage;
it provides a device which can be used by a pet for exercising inside a cage and out of it;
it provides a device allowing a small pet to walk safely inside the device without a risk of being eaten or harmed by a dog or other larger animal or an object outside the device;
it provides a device allowing a pet to walk outside its cage without leaving its excrements on floor and carpets;
it provides a pet rolling device which is easily assembled and disassembled;
it provides a pet rolling device which is leak-proof and lightweight;
it provides a pet rolling device which is easy to operate and clean;
it provides a device for cleaning various floor and other surfaces that does not require its user to manually move the device in the process of cleaning;
it provides a device for cleaning various floor and other surfaces that does not require its user to bend in the process of cleaning;
it provides a device for cleaning various floor and other surfaces which is convenient in use and simple in operation;
it provides a device for cleaning various floor and other surfaces allowing its user to combine the process of cleaning with other activities, like playing a game, watching a television program, reading, talking, etc.;
it provides a device for cleaning floors and other surfaces allowing aged, sick and handicapped people to clean various floor and other surfaces from small-sized litter without a side help;
it provides a device for cleaning floors and other surfaces that is simple to use, easy to replace attachments and inexpensive to manufacture.

The above description and examples should be not construed as limitations on the scope of the invention. Many other variations are possible. Accordingly, the scope of the invention is determined by the claims and their legal equivalents.

What is claimed is:

1. A rolling device for pet exercising and floor cleaning comprising a hollow body, and a litter collector, said hollow body provided with an opening to place a small pet inside the hollow body and remove there from, said hollow body is covered by said litter collector, said litter collector provided with a surface capable of collecting litter.

2. Said device of claim 1, wherein said opening provided with a lid to securely enclose the small pet inside the hollow body.

3. Said device of claim 1, wherein said hollow body provided with a number of ventilation holes for the small pet to breathe.

4. Said device of claim 1, wherein said hollow body and said litter collector are provided with transparent windows for the small pet to view outside objects.

5. Said device of claim 1, wherein said hollow body is spherical.

6. Said device of claim 5, wherein said hollow spherical body made of two hemi-spheres that couple together.

7. Said device of claim 1, wherein said hollow body is cylindrical.

8. Said device of claim 1, wherein said litter collector provided with sticky, bristly and/or magnetic surface.

9. Said device of claim 8, wherein said sticky surface is multi-layer.

10. Said device of claim 1, wherein said litter collector made of water-absorbing material.

11. Said device of claim 1, wherein said litter collector provided with a closeable split.

12. Said device of claim 1, wherein said hollow body provided with two pinholes to securely enclose corresponding pins of a stand allowing the hanging of the device and its rotation in vertical plane.

13. Said device of claim 1 further supplemented with an area guarding to prevent the device to roll outside the designated perimeter.

14. Said device of claim 13, wherein said area guarding comprised a number of strips and connectors to connect said strips to form a desirable configuration of said perimeter and to collapse into stockpile.
